(19) United States
(12) Patent Application Publication
(10) Pub. No.: US 2003/0018695 A1
(43) Pub. Date: Jan. 23, 2003

(54) Information display apparatus and method

(76) Inventors: Fumiaki Kagaya, Miyagi (JP); Shigeki Yokoi, Kanagawa (JP)

Correspondence Address: PEARNE & GORDON LLP, 526 SUPERIOR AVENUE EAST, SUITE 1200, CLEVELAND, OH, 44114-1484, US

(21) Appl. No.: 10/009,073

(22) PCT Filed: Apr. 10, 2001
(86) PCT No.: PCT/JP01/03068

(30) Foreign Application Priority Data
Apr. 10, 2000 (JP) 2000-108125

(51) Int. Cl. G06F 15/16

(52) U.S. Cl. 709/200

(57) ABSTRACT

In information display apparatus 100 having voice call means 101, data on a sender database 104 is retrieved by data retrieval means 103 based on the sender number acquired via calling number acquisition means 102. Application selection means 109 uses terminal resource acquisition means 108 or network resource acquisition means 106 to acquired the resource described in the sender data based on the retrieved sender data and selects the application corresponding to the resource. Display means 111 displays the acquired resource via the application. This displays data related to the sender at call incoming, thus allowing the user to quickly recognize the information on the sender thus enhancing the convenience related to a call.

### TECHNICAL FIELD

The present invention relates to information display apparatus and method that can display electronic mail documents and image data equipped with a call processing protocol and a network protocol. Particularly, the invention relates to information display apparatus such as portable information terminals (e.g. personal digital assistants), a mobile telephone set, or a pager, which is adapted to display data related to a distant party when an incoming call has reached a called party or Internet data or mail data on the distant party acquired from the network.

### BACKGROUND ART

Terminals equipped with internet protocols for access to the internet and connection to a mail server has been in widespread use concerning portable information terminals, portable telephone sets and pagers, as well as wide-spreading of such terminals concerning internet browsers that uses HTML and WML and workstations and personal computers with the proliferation of mails.

However, applications such as internet browsers and mails have been incorporated in terminals for displaying contents on the internet and mails. It was not possible to perform operation linked with a terminal, such as displaying data related to the distant party or acquiring from the network and displaying internet data on the distant party or mail data at call incoming.

While the mail system linked with a telephone set described in the Japanese Patent Publication H07-99508/(1995) discloses a mail system that automatically displays related mails when a call is originated, the system additionally required a user ID and a telephone number correspondence table and a user state variable table in a mail center on top of a related art mail system. This made it necessary to provide a mail center anew. Thus, an existing mail system cannot be used.

### DISCLOSURE OF INVENTION

The invention aims at solving such problems and providing information display apparatus that allows a called party to quickly recognize information of the calling party in linkage with an incoming call, by using an existing internet or mail system, to display mail data on the sender or information such as internet data at call incoming.

Information display apparatus according to the invention comprises voice call means for making voice calls via lines, calling number acquisition means for acquiring the telephone number of a calling party at call incoming, data retrieval means for retrieving sender data acquired via the calling number acquisition means from a sender database that can store a plurality of data sets, each data set comprising a sender name and address, mail address and a network resource (URL) associated with a sender number as well as terminal resources such as text data and graphic data stored in the memory on a terminal, data communication means equipped with an interface for making data communications via lines, network resource acquisition means equipped with a series of network protocols for acquiring network resources by using the data communication means, terminal resource acquisition means for acquiring resources on terminals, application selection means for acquiring a network or a terminal resource corresponding to a predetermined or used-defined calling number from sender data retrieved via the data retrieval means and for selecting the application corresponding to the acquired resource, and display means for displaying on the screen the resource and the application selected via the application selection means.

Via this configuration, it is possible to identify the location and type of a resource from a pre-associated database based on a sender number obtained at call incoming and to display local or network data, thereby quickly recognizing the sender data.

Information display apparatus according to the invention is characterized in that the information display apparatus further comprises a display priority table whereby the user can set which resource is to be displayed first from a set of data described in the sender data retrieved via the data retrieval means.

Via this configuration, it is possible for the user to display arbitrary data among sender data at call incoming.

Information display apparatus according to the invention is characterized in that the display means further comprises additional information selection means in order to display data together with additional information preset by the data or application to be displayed.

Via this configuration, additional information is incorporated into to data displayed at call incoming thus making it easier to recognize the sender information.

Information display apparatus according to the invention is characterized in that, in case a resource to be displayed is mail data, the application selection means retrieves mail data for the mail address described in the sender data retrieved by the data retrieval means from a plurality of mail data sets stored in the memory on a terminal that have been received via the terminal resource acquisition means, and in case corresponding mails are present, selects the mail application to automatically display the mails.

Via this configuration, it is possible to automatically display mail data stored in the terminal based on the sender data corresponding to the sender at call incoming.

Information display apparatus according to the invention is characterized in that, in case a resource to be displayed is mail data, the application selection means automatically connects to a prespecified mail server via the network resource acquisition means and retrieves mail data corresponding to the mail address described in the sender data retrieved by the data retrieval means from mail data on the server, and in case corresponding mails are present, acquires mail data from the server and selects the mail application to automatically display the mails.

Via this configuration, it is possible to automatically display mail data on the mail server based on the sender data corresponding to the sender at call incoming.

Information display apparatus according to the invention is characterized in that, in case a resource to be displayed is mail data, the application selection means retrieves mail data on the mail server via the network resource acquisition means, and retrieves mail data stored in the memory on a terminal via the terminal resource acquisition means to retrieve and acquire the latest mail data from both the network and the terminal, then selects the mail application to display the latest mail data.

Via this configuration, retrieve mail data on a terminal and mail data on a server are retrieved based on the sender data corresponding to the sender at call incoming. Thus it is possible to display the latest mail data at all times.

Information display apparatus according to the invention is characterized in that, in case a resource to be displayed is a resource on the network (URL), the application selection means automatically acquires the corresponding URL data via the network resource acquisition means and selects a web browser application to display the URL data.

Via this configuration, a network resource is acquired and displayed based on the sender data corresponding to the sender at call incoming. Thus it is possible to quickly recognize information related to the sender.

Information display apparatus according to the invention is characterized in that, in case a resource to be displayed is a resource on the terminal such as text data and graphic data, the information display apparatus acquires the corresponding file or data via the terminal resource acquisition means and selects a web browser application to display the resource.

Via this configuration, data stored in the memory on a terminal is acquired and displayed based on the sender data corresponding to the sender at call incoming. Thus it is possible to quickly recognize information related to the sender.

Information display apparatus according to the invention is characterized in that the display means displays data together with sound, music data or voice data preset by the data or application to be displayed.

Via this configuration, the user can recognize the sender data displayed on a screen without watching the terminal screen at call incoming.

Information display apparatus according to the invention is characterized in that the display means displays data together with a background color or background data preset by the data or application to be displayed.

Via this configuration, the user can recognize the sender data once he/she has taken a glimpse of a terminal screen at call incoming.

Information display apparatus according to the invention is characterized in that the sender database is stored in a server on the network and accessed via the network resource acquisition means at call incoming for retrieval and acquisition of the sender data corresponding to the sender number.

Via this configuration, the user can make use of a sender database located on a specific server without updating the sender database.

Information display apparatus according to the invention is characterized in that the sender database is stored in the memory on a terminal and a server on the network and that the data retrieval means searches the sender database stored in the memory at call incoming and, in case the corresponding sender data is not present, accesses the sender database via the network resource acquiring means to search the sender database on the server for target data.

Via this configuration, it is possible to acquire and automatically display sender information on a sender not known to the user via the sender database located on a specific server at call incoming.

### BRIEF DESCRIPTION OF DRAWINGS

FIG. 1 is a block diagram showing a configuration of information display apparatus according to the first embodiment of the invention;

FIG. 2 is a block diagram showing a configuration of information display apparatus according to the second embodiment of the invention;

FIG. 3 is a block diagram showing a configuration of information display apparatus according to the third embodiment of the invention;

FIG. 4 shows an example of a sender database according to the first through third embodiments of the invention;

FIG. 5A shows an example of sender data retrieved by data retrieval means according to the first through third embodiments of the invention;

FIG. 5B shows an example of a display priority table according to the second and third embodiments of the invention;

FIG. 5C shows an example of an application table according to the first through third embodiments of the invention;

FIG. 5D is a flowchart showing the operation of application selection means according to the first through third embodiments of the invention;

FIG. 6 is a block diagram showing a configuration of information display apparatus according to the fourth embodiment of the invention; and

FIG. 7 is a block diagram showing a configuration of information display apparatus according to the fifth embodiment of the invention.

### BEST MODE FOR CARRYING OUT THE INVENTION

Embodiments of the invention will be described referring to the drawings.

(First Embodiment)

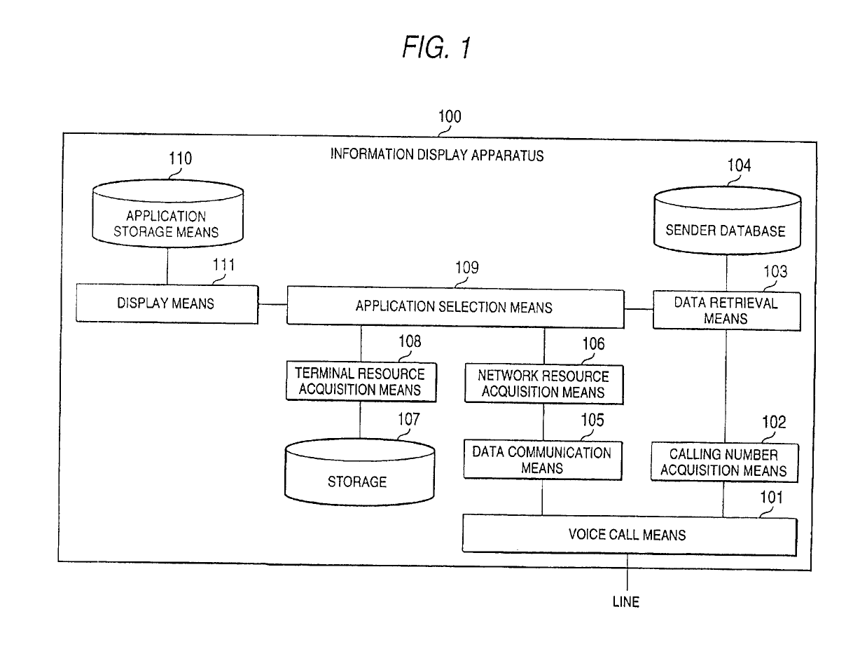

FIG. 1 is a block diagram showing the configuration of a first embodiment of the invention. In information display apparatus 100, voice call means 101 is voice call means for making voice calls via lines and calling number acquisition means 102 is calling number acquisition means for acquiring the telephone number of a calling party at call incoming. Sender database 104 is a sender database that can store plurality of data sets, each data set comprising a sender name and address, mail address and a network resource (URL) associated with a sender number as well as terminal resources such as text data and graphic data stored in the memory on a terminal. Data retrieval means 103 is data retrieval means that retrieves and acquired sender data corresponding to the sender number acquired via the calling number acquisition means 102 acquired via the calling number acquisition means from a sender database from the sender database 104.

Data communication means 105 is data communication means equipped with an interface for making data communications via lines. Network resource acquisition means 106 is network resource acquisition means equipped with a series of network protocols for accessing network resources via the data communication means. A storage 107 indicates a memory on a terminal and is a storage for storing terminal resources such as text string data, graphic data, music data and mail data. Terminal resource acquisition means 108 is terminal data acquisition means for acquiring a specified terminal resource.

Application storage means 110 is storage means for storing mail applications and web browser applications stored in the memory on a terminal. Application selection means 109 is selection means for determining whether the resource to be displayed is a terminal resource or a network resource from the resource described in the sender data retrieved via the data retrieval means 103, acquiring the resource via the terminal resource acquisition means 108 or the network resource acquisition means 106, and selecting the application corresponding to the resource from the application storage means 110. Display means 111 is display means for displaying the application and the acquired resource selected via the application selection means 109.

Operation outline of the first embodiment of the invention will be described by using FIG. 1. The voice call means 101 notifies the calling number acquisition means 102 of call incoming at incoming of a voice call. The calling number acquisition means 102, acquiring the sender number, outputs the sender number to the data retrieval means 103. The data retrieval means 103 retrieves sender data from the sender database 104 based on the sender number output from the calling number acquisition means 102 and outputs the sender data to the application selection means 109.

The application selection means 109 determines whether the resource to be displayed is a terminal resource or a network resource based on the resource described in the sender data output from the data retrieval means 103, acquires the resource via the terminal resource acquisition means 108 or the network resource acquisition means 106, selects the application corresponding to the resource from the application storage means 110, and outputs the resource and the application to the display means 110. The display means 110 displays the resource and the application output from the application selection means 109.

As mentioned earlier, according to the first embodiment of the invention, a resource on a terminal or the network is acquired and displayed from the sender data corresponding to the sender number at call incoming. This eliminates the need for retrieving the data corresponding to the sender after the called party has answered the incoming call, allowing the data related to the user to be recognized quickly thus enhancing the convenience related to a call.

(Second Embodiment)

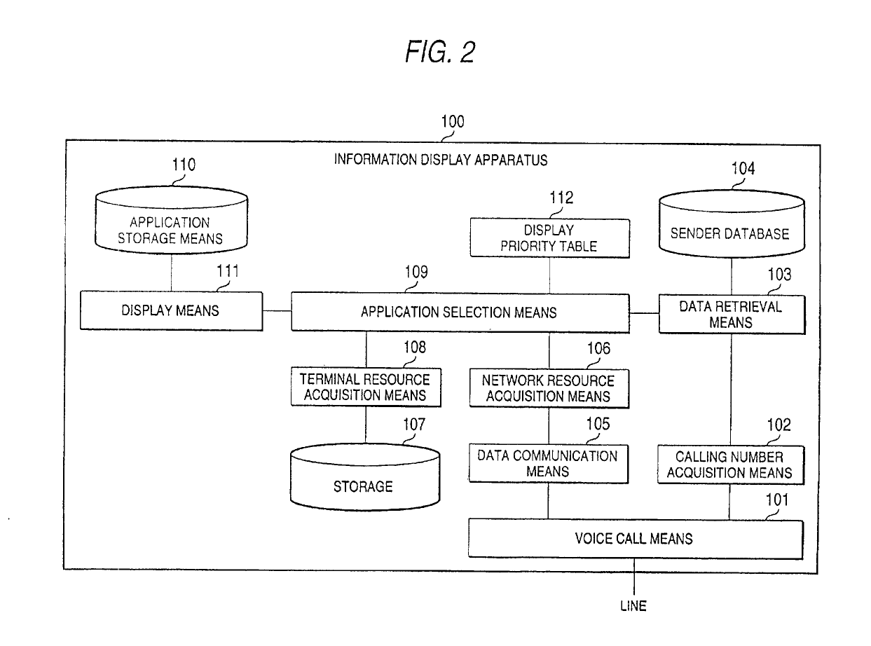

FIG. 2 shows a second embodiment of the invention, which differs from the first embodiment in that a display priority table 112 is further provided in the application selection means 109. The display priority table 112 is a user-defined table that describes which resource is to be displayed first among a plurality of resource names or resource locations described in the sender data retrieved via the data retrieval means 103.

Operation outline of the second embodiment of the invention is similar to that of the first embodiment, except that the application selection means 109 references the display priority table 112 before acquiring a resource to be displayed in the determination process.

As mentioned earlier, according to the second embodiment of the invention, a resource corresponding to the sender number is displayed in accordance with the display priority table 112 preset by the user. This makes it easy for the user to recognize sender data thus enhancing the convenience related to a call.

(Third Embodiment)

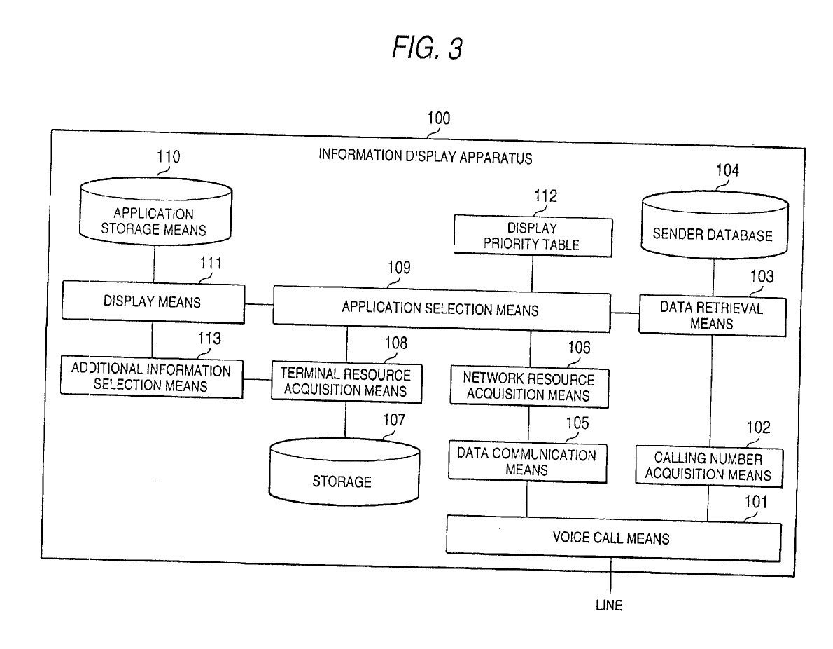

FIG. 3 shows a third embodiment of the invention, which differs from the first embodiment in that additional information selection means 113 is further provided in the display means 111. The additional information selection means 113 acquires additional information described in the sender data output from the data retrieval means 103 via the terminal resource acquisition means 108 to display the additional information together with the resource and the application, in displaying the resource and the application output from the application selection means 109.

Operation outline of the third embodiment of the invention is similar to that of the first embodiment, except that the display means 111 displays the additional information described in the sender data output from the data retrieval means 103 via the terminal resource acquisition means 108, together with the resource and the application, in displaying the resource and the application output from the application selection means 109.

As mentioned earlier, according to the third embodiment of the invention, the resource described in the sender data via the selected application together with additional information. This allows the user to recognize sender data more easily.

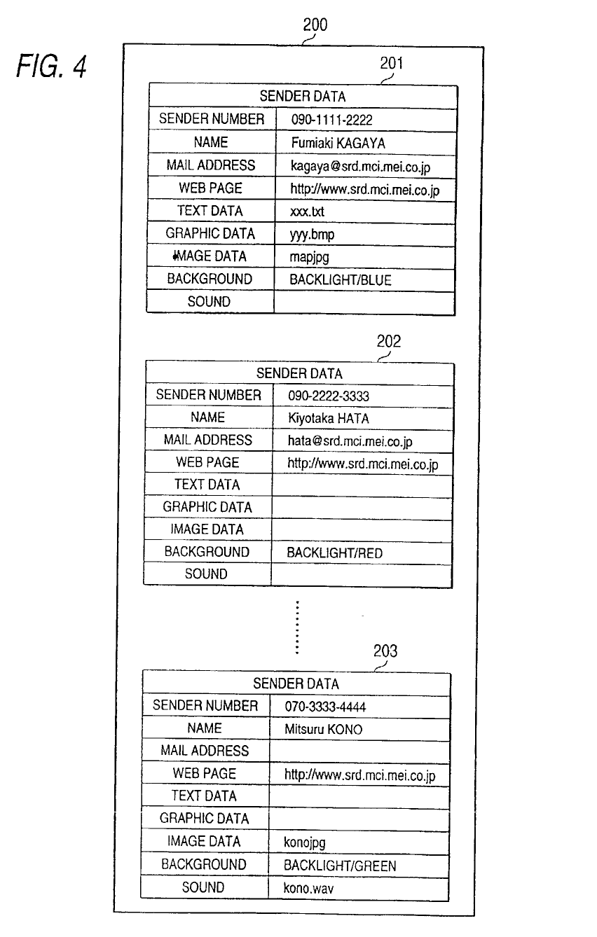

FIG. 4 shows an example of the sender database according to the first through third embodiments of the invention. The database has a plurality of sender data sets 202 through 203. Each of the sender data sets 201, 202, 203 has fields for describing a sender number, a corresponding name, mail address, web page, text data, graphic data, image data, background display data, and voice or music data.

The data retrieval means 103 in the first through third embodiments of the invention retrieves sender data that matches the sender database 104 (of which the configuration is shown in FIG. 4) and the calling number acquisition means 102. Storage of sender data into the sender database and retrieval of sender data use a method such as simple matching and hashing. The same advantage is obtained when the sender data uses an arbitrary field name and an arbitrary field on top of the field names shown in the example of FIG. 4.

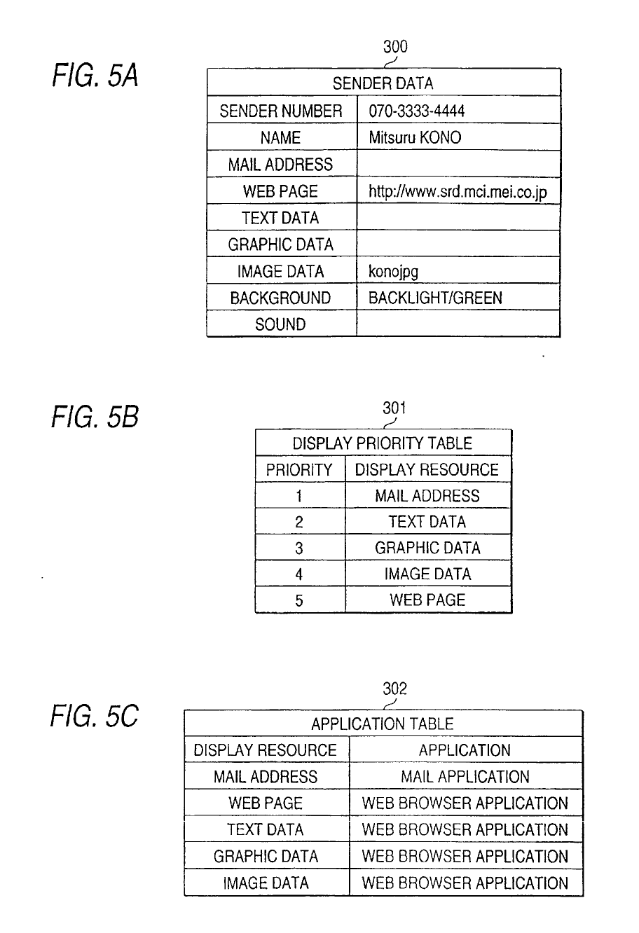

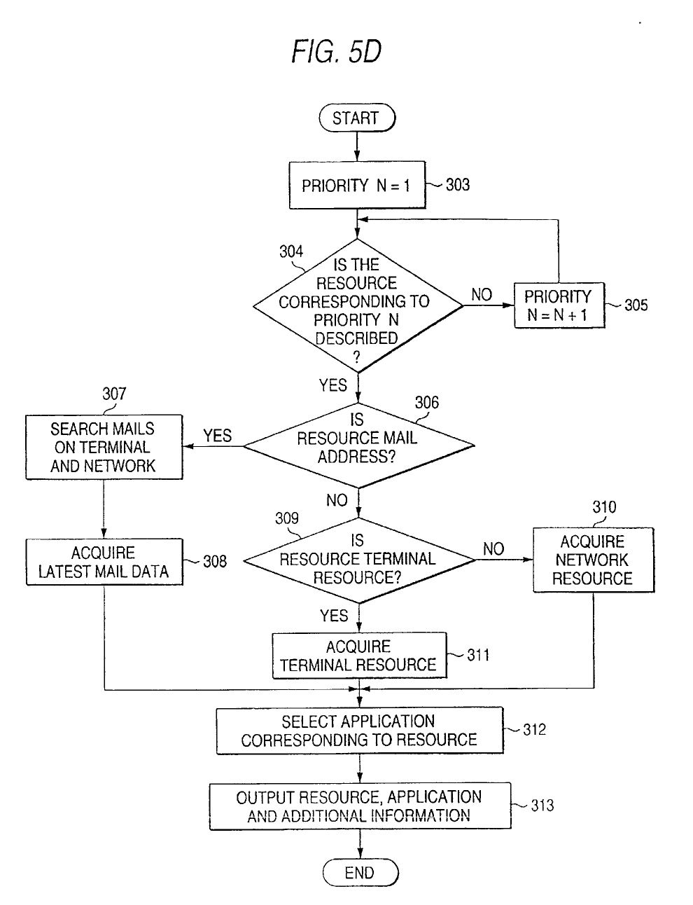

Next, operation of the application selection means in the in the first through third embodiments of the invention will be described. FIG. 5A shows an example of the display priority table 301, with the resources specified in the order of priority, mail address, text data, graphic data, image data and web data. FIG. 5B is an example of the application table where applications to be selected are keyed to the resources displayed. In case the resource is a mail address, the mail application is selected. In case the resource is a web page, text data, graphic data or image data, the web browser application is selected.

FIG. 5D shows the operation flow of the application selection means 109. The flow of FIG. 5D will be explained below. The application selection means 109, receiving output of sender data from the data retrieval means 103, initializes the priority N (step 303). Then the application selection means 10 determines whether the resource corresponding to the priority N is described in the sender data field (step 304). In case the resource corresponding to the priority N is not described, 1 is added to the priority N (step 305) and investigation of the corresponding resource is retried.

In case the resource corresponding to the priority is described, the application selection means 10 determines whether the resource is a mail address. In case the resource is a mail address, connection is established to mail data corresponding to mail addresses stored in the memory on a terminal and a predetermined mail server for retrieval of mail data on the mail server (step 307).

Internet mails have mail sending date recorded in the mail data thus comparison between mails is easy. The mail data determined to be the latest mail is acquired via the terminal resource acquisition means 108 or network resource acquisition means 106 (step 308), followed by next operation.

In case the resource is not a mail address, it is determined whether the resource is stored in the memory on a terminal or is a network resource (step 309). In practice, the head character string of the resource description is checked concerning whether the string is described in a schema using a network protocol (typically “http://” or “ftp://”).

In case the resource is a network resource, a request for acquisition of the resource corresponding to the network resource acquisition means 106 is made to acquire the network resource (step 310). In case the resource is determined to be a resource on a terminal, the resource corresponding to the terminal resource acquisition means 108 is acquired (step 311).

Next, the application selection means 109 references the application table 302 to select an application (step 312) and outputs the resource name, application name and additional information described in the sender data (step 313) to terminate the operation. In this example, the resource is the resource on a terminal “kono.jpg”, the application is the web browser, and additional information is that backlight is output is green.

As mentioned earlier, the application selection means 109 in the third embodiment of the invention acquires from a terminal or the network a resource to be displayed based on the sender data output from the data retrieval means 103 that is based on the display priority table 112 to select an application corresponding to the resource. This displays the resource intended by the user at call incoming so that it is possible to display, as sender information, arbitrary data including company data of the sender, sender's identification photograph and profile, instead of just displaying the sender number or name data of the sender as in related art portable telephone sets.

(Fourth Embodiment)

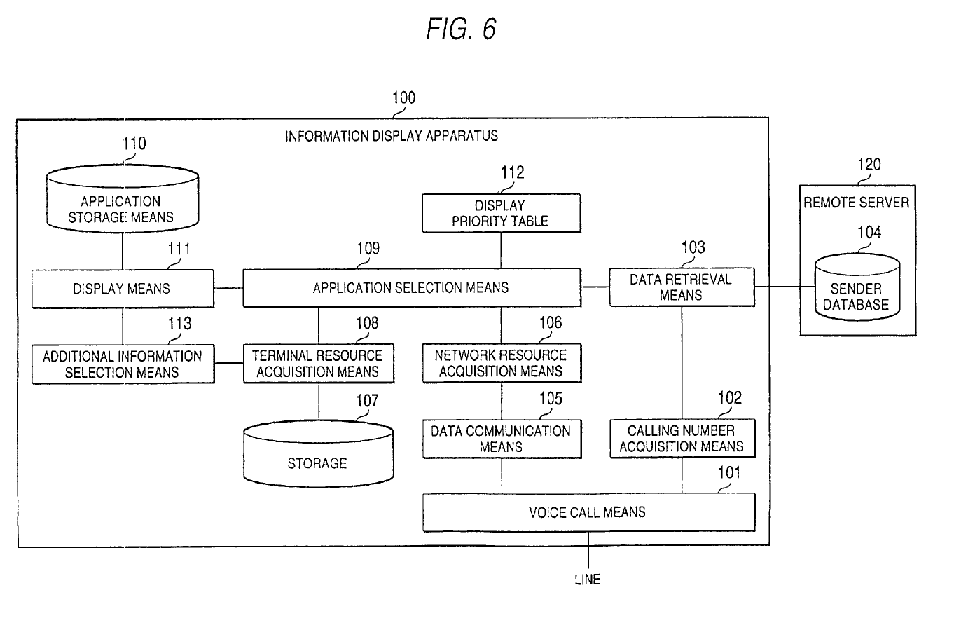

FIG. 6 shows a fourth embodiment of the invention, which differs from the first to third embodiments in that the sender database 104 is provided in a server 120 on the network. The information display apparatus 100 communicates with the server 120 on the network via the internet, LAN, WAN and/or public networks. Data retrieval means 103 searches the sender database 104. Method of processing data including display information in this embodiment is as shown in FIG. 1.

(Fifth Embodiment)

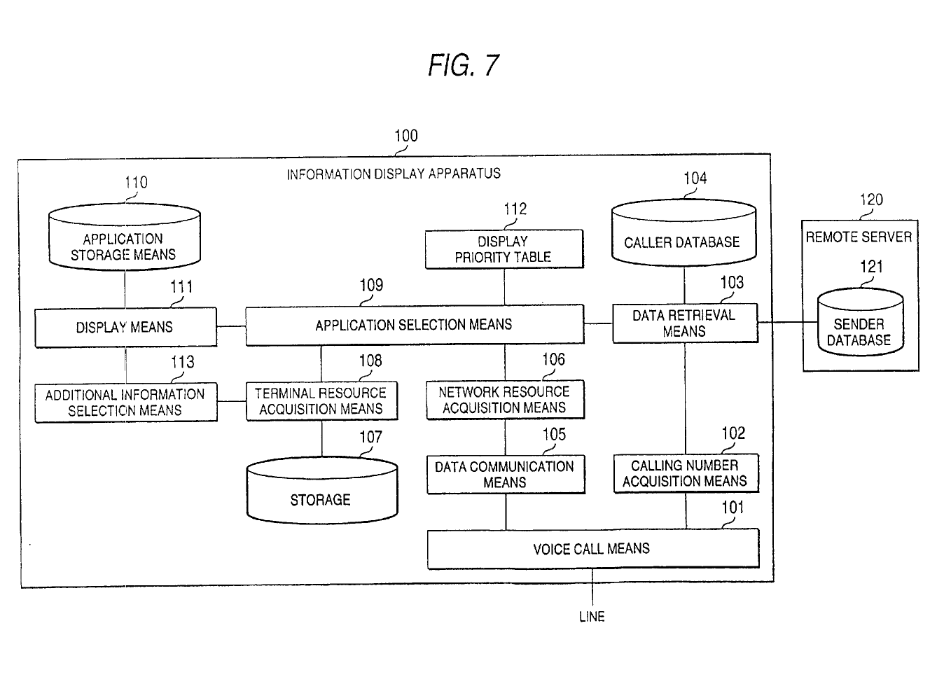

FIG. 7 shows a fifth embodiment of the invention, which differs from the first to fourth embodiments in that the sender databases are provided in a terminal and a server on the network. The terminal is provided with the sender database 104 and the server on the network a sender database 121. Method of processing data including display information in this embodiment is as shown in FIG. 1.

As mentioned earlier, according to the fifth embodiment of the invention, it is possible to acquire and automatically display the information on the sender not known to the user, the information not found in the sender database 104 on the user terminal, by using the sender database on a specific server, thus allowing the user to acquire information of the sender before answering a call.

### INDUSTRIAL APPLICABILITY

As mentioned earlier, according to the invention, the voice call means notifies the calling number acquisition means of call incoming at incoming of a voice call. The data retrieval means searches the sender database for the sender data corresponding to the acquired sender number. The application selection means acquires the resource corresponding to the sender described in the sender data via the terminal resource acquisition means or network resource acquisition means, and selects the application corresponding to the resource. The display means displays the resource by using the selected application. The user has only to register the internet resource (URL) information on the company of a sender in a database for later display of company data, or has only to register image data such as a sender's identification photograph and notes in a database for display of such data at call incoming. This allows the user to quickly recognize the information on the distant party thus enhancing the convenience related to a call.

1. Information display apparatus comprising:
voice call means for making voice calls via lines;
calling number acquisition means for acquiring the telephone number of a calling party at call incoming;
data retrieval means for retrieving sender data acquired via said calling number acquisition means from a sender database that can store a plurality of data sets, each data set comprising a sender name and address, mail address and a network resource (URL) associated with a sender number as well as terminal resources such as text data and graphic data stored in the memory on a terminal;
data communication means equipped with an interface for making data communications via lines;
network resource acquisition means equipped with a series of network protocols for acquiring network resources by using said data communication means;
terminal resource acquisition means for acquiring resources on terminals;
application selection means for acquiring a network or a terminal resource corresponding to a predetermined or used-defined calling number from sender data retrieved via said data retrieval means and for selecting the application corresponding to the acquired resource; and
display means for displaying on the screen the resource and the application selected via said application selection means.

2. Information display apparatus according to claim 1, further comprising a display priority table to make the user be able to set which resource is to be displayed first from a set of data described in the sender data retrieved via said data retrieval means.

3. Information display apparatus according to claim 1 or 2, wherein said display means further comprises additional information selection means and that said display means acquires additional information via said terminal resource acquisition means in accordance with additional information described in said sender data in order to display data together with the additional information.

4. Information display apparatus according to any one of the preceding claims, wherein, in case a resource to be displayed is mail data, said application selection means retrieves mail data for the mail address described in the sender data retrieved by said data retrieval means from a plurality of mail data sets stored in the memory on a terminal that have been received via said terminal resource acquisition means, and in case corresponding mails are present, selects the mail application to automatically display the mails.

5. Information display according to any one of the preceding claims, wherein, in case a resource to be displayed is mail data, said application selection means automatically connects to a prespecified mail server via said network resource acquisition means and retrieves mail data corresponding to the mail address described in the sender data retrieved by said data retrieval means from mail data on the server, and in case corresponding mails are present, acquires mail data from the server and selects the mail application to automatically display the mails.

6. Information display apparatus according to any one of the preceding claims, wherein, in case a resource to be displayed is mail data, said application selection means retrieves mail data on the mail server via said network resource acquisition means, and retrieves mail data stored in the memory on a terminal via said terminal resource acquisition means to retrieve and acquire the latest mail data from both the network and the terminal, then selects the mail application to display the latest mail data.

7. Information display apparatus according to any one of the preceding claims, wherein, in case a resource to be displayed is a resource on the network (URL), said application selection means automatically acquires the corresponding URL data via said network resource acquisition means and selects a web browser application to display the URL data.

8. Information display apparatus according to any one of the preceding claims, wherein, in case a resource to be displayed is a resource on the terminal such as text data and graphic data, said information display apparatus acquires the corresponding file or data via said terminal resource acquisition means and selects a web browser application to display the resource.

9. Information display apparatus according to any one of the preceding claims, wherein said display means displays data together with sound, music data or voice data preset by the data or application to be displayed.

10. Information display apparatus according to any one of the preceding claims, wherein said display means displays data together with a background color or background data preset by the data or application to be displayed.

11. Information display apparatus according to any one of the preceding claims, wherein said sender database is stored in a server on the network and accessed via said network resource acquisition means at call incoming for retrieval and acquisition of the sender data corresponding to said sender number.

12. Information display apparatus according to any one of the preceding claims, wherein sender database is stored in the memory on a terminal and a server on the network and that said data retrieval means searches the sender database stored in said memory at call incoming and, in case the corresponding sender data is not present, accesses the sender database via said network resource acquisition means to search the sender database on the server for target data.

13. A portable information terminal, wherein said portable information terminal uses radio link networks and comprises information display apparatus according to any one of the preceding claims.

14. A telephone set using public networks and comprising information display apparatus according to any one of claims 1 through 12.

15. Information display method comprising the steps of:
acquiring the telephone number of a calling party at call incoming;
retrieving sender data acquired via said calling number acquisition step from a sender database that can store a plurality of data sets, each data set comprising a sender name and address, mail address and a network resource (URL) associated with a sender number as well as terminal resources such as text data and graphic data stored in the memory on a terminal;
acquiring network resources and resources on terminals;
acquiring a network or a terminal resource corresponding to a predetermined or used-defined calling number from sender data retrieved via said data retrieval means;
selecting the application corresponding to the acquired resource; and
displaying on the screen the resource and the application selected via said application selection means.
